(19) United States
(12) Patent Application Publication
(10) Pub. No.: US 2007/0205243 A1
(43) Pub. Date: Sep. 6, 2007

(54) Multi-positionable caddy and organizer system

(76) Inventors: Kenneth Lee Potts, Solana Beach, CA (US); Debra Lee Potts, Solana Beach, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/799,887

(22) Filed: May 2, 2007

Related U.S. Application Data
(63) Continuation-in-part of application No. 10/881,034, filed on Jun. 29, 2004.

(51) Int. Cl. B60R 7/00

(52) U.S. Cl. 224/539

(57) ABSTRACT

A caddy device for carrying and organizing articles being transported in a vehicle. The caddy is user-configurable to one or multiple individual compartments for optimizing their dimensions for carrying, holding and organizing articles such as filled shopping bags or food and drinks. Employing multiple dividers the device may be deployed to numerous different positions to adjust the compartment size. An optional cooler bag for transport of cold items is also engagable within the compartments.

This application is a continuation-in-part of pending U.S. application Ser. No. 10/881,034 filed Jun. 29, 2004.

### BACKGROUND OF THE INVENTION

The present invention relates to a caddy and organizer system and pertains more particularly to arrangements for improved collapsibility, positionability, and engagement of shopping caddies, shopping bags, beverage containers and various other items to be organized.

### DISCUSSION OF PRIOR ART

Groceries are typically bagged at the checkout counter in a plastic bag or a collapsible paper bag. The paper and plastic bags are generally considered to be disposable items. Alternatively, reusable canvas bags are sometimes used to transport groceries. Any of the various types of grocery bags are conventionally transported from the store in a cargo area of a motor vehicle, such as the trunk of a car or anywhere on the floor of a vehicle such as a van, a minivan, or a sports utility vehicle. In addition to groceries, other items are frequently transported in vehicles, such as picnic items, sports equipment, nursery plants and beverage containers.

However, it has been conventionally recognized that bags can tip, shift and spill. In response to this problem, holders (or caddies) have been used to secure grocery bags and other transported items in motor vehicles. However, possibly due in part to the expense and/or cumbersomeness of conventional shopping caddies, these devices have not been widely used.

U.S. Pat. No. 4,226,348 to Dottor et al. discloses a grocery bag holder with a rigid bottom mat member. The upstanding sides of the grocery bag holder disclosed in this patent can be folded down or collapsed down to lie flat along the bottom mat. However, the bottom mat itself is not collapsible.

The public's ever-increasing reliance on transportation by private motor vehicle requires more and more people to be in their motor vehicles for greater periods of time. Commuting times are increasing, as well as activities and responsibilities of family members. Associated personal items, such as food, beverages, cosmetics, entertainment equipment, and paper often become disorganized and scattered about the vehicle, especially when it is in motion. Vehicle accidents often occur when a driver becomes distracted while attempting to fetch one of these items from the floor of the vehicle, especially in vans of any size.

Several vehicle organizer systems are known. In general, they contain one or more compartments for containing particular items. Some systems are collapsible. However, their versatility is usually limited in one or more different ways.

### SUMMARY OF THE INVENTION

The present invention relates to improved designs for shopping caddies and organizers for various articles in moving vehicles. At least some embodiments of the present invention provide a shopping caddy system which is more adjustable, lighter in weight, more easily portable, and less expensive than conventional shopping caddy systems. The organizer system of the present invention can be adapted to a variety of configurations for holding articles of various sizes, and is collapsible for storage and transport. The system is adaptable to a variety of uses, for example, vehicle, home, and recreational uses.

In some embodiments of the present invention, upstanding, somewhat rigid end panels can be rotated or folded downward against an intermediate divider or the bottom panel of the organizer. This gives the bottom of the caddy additional rigidity and a larger effective base when a compartment formed between the end panel and the intermediate divider is empty of bags.

In some embodiments of the present invention, the caddy can be collapsed so that its end panels and intermediate dividers form a compact stack, having a relatively small “footprint” corresponding to the length and width of the end panels. This is an advantage over collapsible caddies with rigid bottom panels because the “footprint” for these caddies in the collapsed position would correspond to the length and width of the rigid and relatively large bottom panel. On the other hand, the end-to-end collapsible embodiments of the present invention work especially well in conjunction with the rigid downward-folding end panels described above.

According to a first aspect of the invention, a device is provided for organizing or holding shopping articles in an upright position. The device includes a rigid first end panel, a rigid second end panel, a rigid first divider panel, a rigid second divider panel, and a rigid center divider panel positioned between the first divider and second divider panels and approximately parallel thereto. Although many preferred embodiments of “rigid” panels will be capable of some degree of elastic deformation as will be discussed in detail below, they are to be distinguished from pliable fabric, such as nylon or other fabric, which is not herein considered to be rigid.

A pliable base is connected to at least side edges of the first and second end panels, the first and second divider panels, and the center divider panel. The base is structured to constrain the first end panel, the second end panel, the first divider panel, the second divider panel and the center divider panel relative to each other so that the distance between the panels is substantially the same.

The base also includes a first panel between the first end panel and the first divider panel, a second panel between the first divider panel and the center divider panel, a third panel between the center divider panel and the second divider panel, and a fourth panel between the second divider panel and the second end panel. The base is further structured to be selectively collapsible between a closed position with the first end panel, the second end panel, the first divider panel, the second divider panel and the center divider panel in close face-to-face proximity with each other, and an open position with the first end panel, the second end panel, the first divider panel, the second divider panel and the center divider panel being spaced apart. The first end panel is moveable between a first angular orientation substantially parallel to the first divider panel and a second angular orientation inclined substantially perpendicular to the first divider panel.

For example, the first end panel will generally be placed in the first orientation when the caddy is to receive a grocery bag or other articles between the substantially parallel and spaced apart first end panel and the first divider panel.

On the other hand, the base will generally be in the second orientation when the caddy is not going to hold a grocery bag in the compartment between the first end panel and the first divider panel. In the second angular orientation, the inclined rigid first panel can help prevent the caddy from tipping over by providing added support to the first divider panel and/or by providing a longer effective base for the caddy. In preferred embodiments, the first end panel will be put in the second angular orientation by being rotated 90 degrees so that it is lying along the bottom plane of the caddy.

Additional positioning of the device is contemplated. For example, in additional embodiments, the center divider panel is composed of two rigid panels arranged substantially parallel to one another such that each of the two panels is movable between a first angular orientation substantially parallel to the first and second divider panels and a second angular orientation inclined substantially perpendicular to the first and second divider panels. When placed in the second angular orientation, an enlarged compartment in the device is formed, suitable for containing a cooler bag, for example.

In additional embodiments, the first divider panel and second divider panel are movable between a first angular orientation substantially parallel to the center divider panel and a second angular orientation inclined substantially perpendicular to the center divider panel. When placed in this position, the device forms a “W” shape, as viewed from a side. This positioning provides for additional storage and holding capability of different sizes and types of articles.

According to a second aspect of the present invention, a device is provided for organizing or holding shopping articles in an upright position. The device includes a first end panel having a first side edge, a second side edge and a bottom edge, a second end panel having a first side edge, a second side edge and a bottom edge, a center divider panel having two substantially parallel divider members, each having a first side edge, a second side edge and a bottom edge, and a pliable base.

The pliable base defines two side panels and a bottom panel connected to at least one side edge of the end panels and center divider panel and structured to constrain the first end panel, the second end panel, and the center divider panel to each other so that the first divider panel is located substantially between the first end panel and the second end panel, with the base being collapsible between an open position with the first end panel, the second end panel and the center divider panel being spaced apart and substantially parallel to each other, and a closed position with the first end panel, the second end panel and the center divider panel being in a close substantially face-to-face adjacency or engagement and substantially parallel to each other.

As used herein, “spaced apart” means spaced away from each other so that a reasonably-sized grocery bag can fit in between successive panels. As used herein, “in close proximity” means either contiguous or at least close enough together so that a reasonably-sized grocery bag cannot fit between successive panels.

### BRIEF DESCRIPTION OF THE DRAWINGS

The nature, goals, and advantages of the invention will become more apparent to those skilled in the art after considering the following detailed description when read in connection with the accompanying drawing, illustrating by way of examples the principles of the invention, in which like reference numerals identify like elements throughout, wherein:

FIG. 1 is a perspective view of a fully open shopping caddy system according to the present invention;

FIG. 2 is a perspective view showing an additional arrangement of the shopping caddy system of FIG. 1 with the center divider panels rotated to be inclined relative to the divider panels;

FIG. 3 is a is a perspective view showing an additional arrangement of the shopping caddy system of FIG. 1 with both end panels rotated to be inclined relative to the divider panels;

FIG. 4 is a is a perspective view showing an additional arrangement of the shopping caddy system of FIG. 1 with both end panels rotated to be inclined relative to the divider panels and with the center divider panels rotated to be inclined relative to the divider panels;

FIG. 5 is a perspective view showing an additional arrangement of the shopping caddy system of FIG. 4 with both end panels in a raised position;

FIG. 6 is a perspective view showing an additional arrangement of the shopping caddy system of FIG. 3 with both end panels in a raised position;

FIG. 7 is a is a perspective view showing an additional arrangement of the shopping caddy system of FIG. 1 in the “W” configuration;

FIG. 8 is a side view of the shopping caddy of FIG. 1 in the fully open position;

FIG. 9 is a side view of the shopping caddy of FIG. 1 in a partially collapsed position;

FIG. 10 is a side view of the shopping caddy of FIG. 1 when the caddy has almost reached the fully collapsed position;

FIG. 11 is a bottom view of the shopping caddy in the fully open position;

FIG. 12 is a bottom view of the shopping caddy in the partially collapsed position of FIG. 7;

FIG. 13 is a perspective view of the shopping caddy system in a collapsed and secured position; and

FIG. 14 is a perspective view of the shopping caddy system of FIG. 1 with both end panels rotated to be inclined relative to the divider panels and a shopping bag partially placed in one of the center compartments.

FIG. 15A shows a perspective view of another embodiment of the disclosed device and system which provides an insulated center section located between collapsible end compartments with the center compartment adapted for insulated transport of cold beverages or hot as the case may be.

FIG. 15B depicts the embodiment of FIG. 15A showing the end compartments partially collapsed to provide a stabilization support to the center section.

FIG. 15C depicts the device of 15A and 15B wherein the end compartments are fully collapsed and lower handles are in a raised position to aid carrying of the device.

FIG. 15D shows an optional surface mount component which is adapted for easy engagement with the bottom of any embodiment of the device herein through a top surface hook and loop engagement. A thermal element can provide heat or cold to an overriding caddy during transport.

FIG. 15E depicts an optional thermal support surface on which the caddy may be placed to maintain the temperature of the center compartment.

### DESCRIPTION OF THE PREFERRED EMBODIMENTS

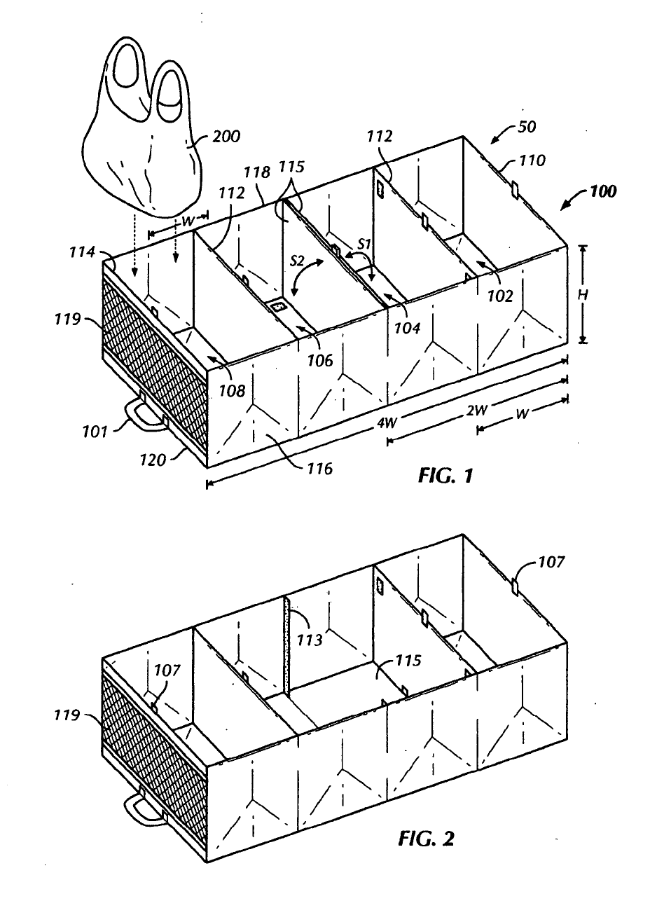

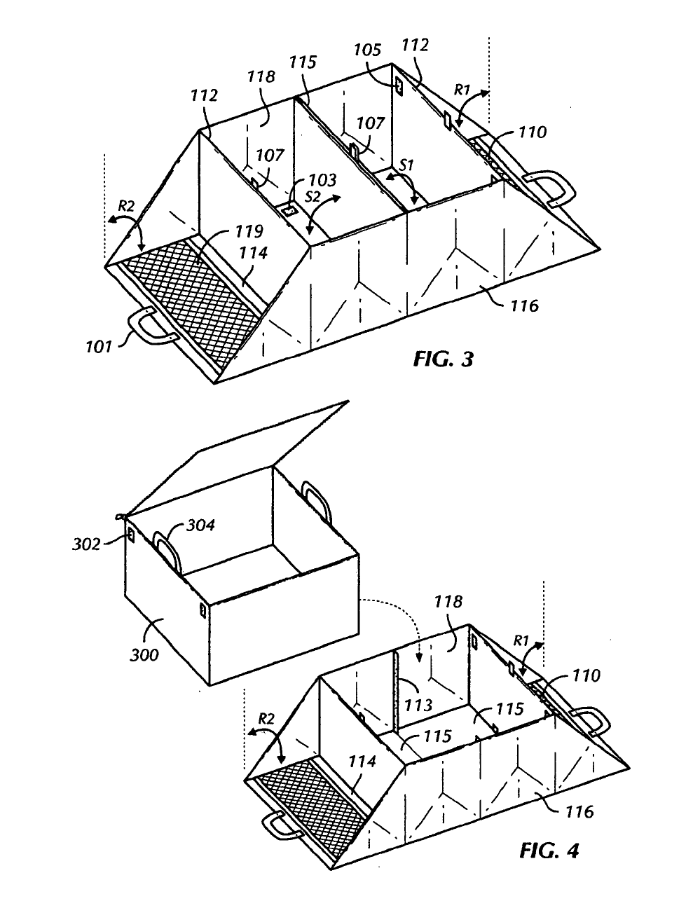

FIGS. 1 to 15E show a shopping caddy and organizer system 50 in accordance with the invention, including a shopping caddy 100 and a shopping bag 200. Caddy 100 holds the bags upright, for example, in the trunk of a car or on the floor of a van. Although this preferred embodiment caddy 100 is not fixed in the vehicle, shopping bag 200 will generally be restrained from sliding around or tipping when it is constrained through caddy 100 as compared with such a bag placed separately in a car. While the caddy system is particularly adapted for holding shopping articles, it may have many other uses such as shipping and storage of other articles.

As explained below in more detail, this preferred caddy 100 is advantageous because it collapses in the end-to-end direction, thereby allowing the collapsed caddy 100 to have a smaller length and width footprint than it would if collapsed in a side-to-side direction or top-to-bottom direction, which other configurations would typically result in the bottom panel being non-foldable. Also, end panels 110, 114 can be rotated inwardly toward intermediate divider panels 112 to lie flat against the bottom panel 120 of the caddy. This feature can be used to provide a longer and more rigid base for the caddy when one or both endmost compartments are not filled with and supported by shopping bags. This is especially important because bottom panel 120 is pliable to allow for the end-to-end caddy collapsing action mentioned earlier in this paragraph.

As shown in FIG. 1, caddy 100 includes first end panel 110, two intermediate divider panels 112, center divider panels 115, second end panel 114, a first side panel 116, a second side panel 118, and a bottom panel 120. The panels 110, 112, 114, 115, 116, 118, and 120 define four rectangular compartments 102, 104, 106, 108. It is contemplated herein that by designing caddies with more or fewer intermediate divider panels 112, different numbers of compartments may be obtained. In addition, the compartments could be square shaped as well. While the compartments are shown as each being the same size as the others, that is not a requirement of the invention.

Side panels 116, 118 and bottom panel 120 are preferably made of pliable nylon fabric. End panels 110, 114 and intermediate divider panels 112 and center divider panel 115 are formed as somewhat rigid boards (preferably made of plastic, rubber or hardboard-like condensed cardboard, or the like) encased in a suitable pliable sheet such as nylon. The “somewhat” rigid boards are preferably more flexible and elastic than a cardboard box or the wire mesh of a typical shopping cart, but much more rigid than cloth. The desired balance of rigidity and flexibility would be something like that provided by the sole of a light duty shoe. This intermediate degree of rigidity provides good support for bags in caddy 100, while allowing plenty of give to prevent breakage of the panels. As used herein, the word “rigid” will be used to generically denote the preferable intermediate degree of rigidity described above, as well as higher degrees of rigidity.

The nylon casing of the rigid boards of panels 110, 112, 114, and 115 allows the panels to be sewn to the nylon side and bottom panels 116, 118, 120 and provides the caddy with an attractive, uniform color and texture. Of course, materials other than nylon could be employed for the fabric casings. It is not essential to the invention that there be any fabric casing, but it is part of the preferred embodiment.

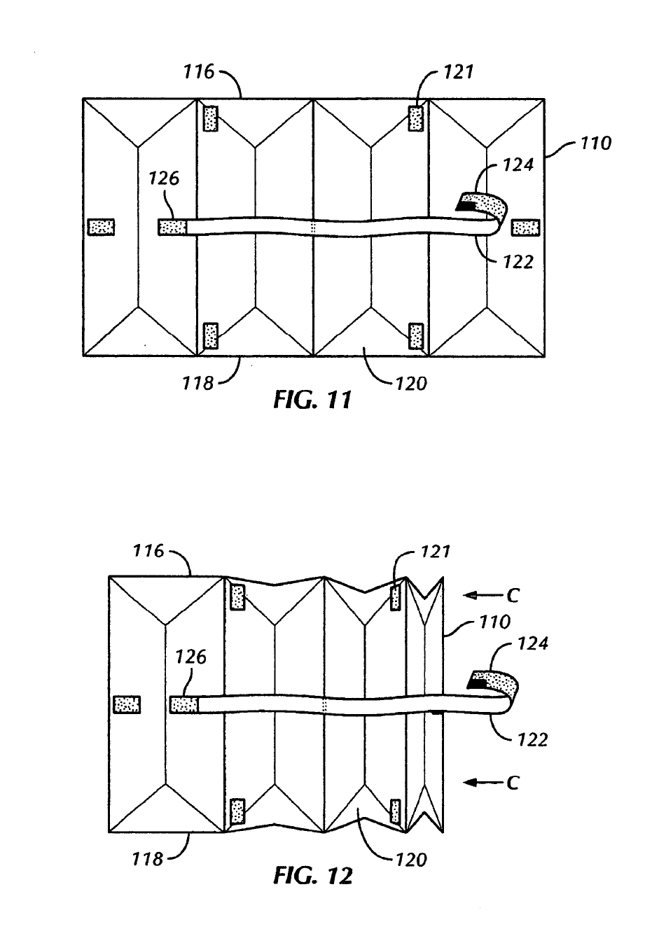

As seen in FIG. 11, caddy 100 further includes a strap 122 with first a hook and loop fastening means such as that sold under the trademark Velcro® End 126 and end 124 can be secured together, for example. A portion of strap 122 is sewn to bottom panel 120 to hold it in place. The strap is long enough to hold caddy 100 in a collapsed and stacked state (see FIG. 11). Because of the end-to-end collapsing action of the caddy, the stack held by strap 122 also has a small footprint. Due to the careful dimensioning of the caddy in the stacked state it is nearly flush along its edges. This makes for a compact, attractive stack which is easy to carry during shopping excursions. Because caddy system 50 forms such a nice stack, strap 122 is a very useful adjunct of the preferred caddy system 50, but it is not an essential element of the invention.

Because the ends 124, 126 are formed with complementary Velcro portions, they are detachably attachable so that the length of the loop circumscribed by strap 122 can be varied depending on the height of the stack, which in turn depends upon whether the user chooses to secure bags, for example, in addition to the stack. Of course, other adjustable attachably detachable structures could be used, such as buttons, snaps, magnets, tieable cords, and so on.

At least some conventional caddies are made to be mounted to a car trunk. In these conventional caddies, the mounted caddy prevents tipping or translation of the caddy and its bags. In a preferred embodiment, no means are provided to mount caddy 100 to a floor or surface, so the manner in which unmounted caddy 100 prevents motion and tipping of the grocery bags will be described in some detail. However, as seen in FIGS. 9 and 10, caddy 100 alternatively has non-skid feet 121, which aid in keeping the device fixed and upright, especially in a moving vehicle. However, in other embodiments of the invention, it is contemplated that the caddy is mounted or secured to a vehicle. For example, the caddy could be mounted to the floor of the trunk, or it could be integrated with the rear portion of the back seat of the vehicle.

First, with respect to tipping, when a bag is used without the caddy, its weight is distributed over a fairly small width W (see FIG. 1). Further, the center of gravity of a loaded bag is likely to not be close to the bottom of the bag. When forces tend to rotate the bag about its bottom edge, tending to thereby tilt up the base of the bag about one of its bottom edges, the countervailing weight of the bag will act only along a fairly short moment arm W and will only produce a limited moment to resist this tipping.

On the other hand, when a bag is constrained by caddy 100 in compartment 104 or 106, for example, to act as a unit, the weight of the bag acts along longer moment arm 2W so that the weight of the bag produces a much greater moment to resist the tipping forces. Similarly, if all four compartments 102, 104, 106, 108 are filled with bags, the unit has a base which is 4W long. This long effective base is very resistant to tipping due to its length.

Second, with respect to sliding or translation of the bags, the constraint provided by caddy 100 effectively prevents such translation of either the bags or the caddy itself. This is because the combined weight of bags result in greater static frictional forces that must be overcome before caddy 100 will move along the surface upon which it rests. It is also noted that some limited degree of translation of the caddy, for example, within the trunk of a moving car, will generally not cause damage to or tumbling of the groceries.

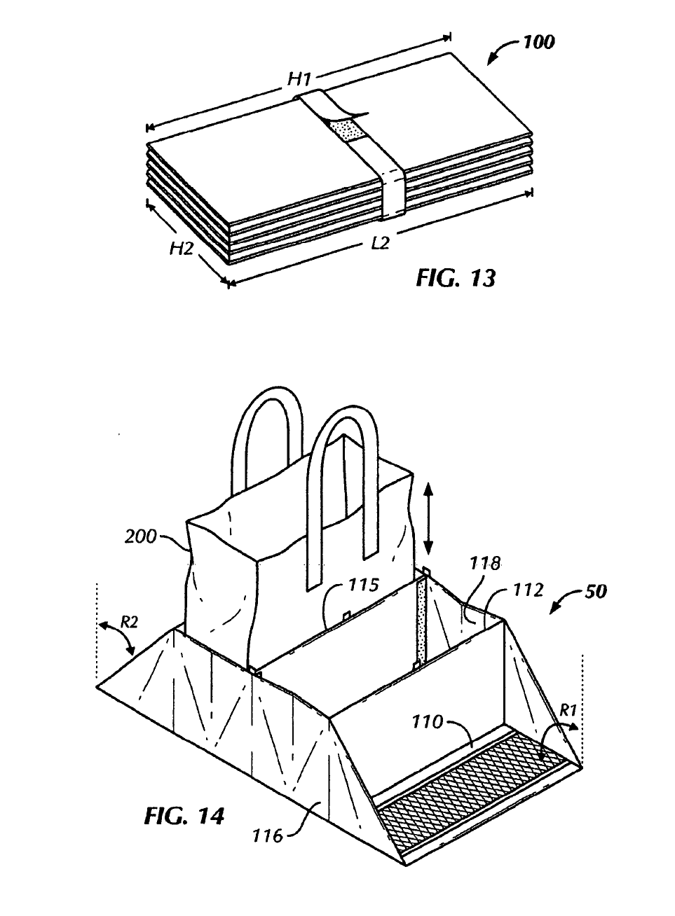

While the preferred caddy does not have mounting structures, it is noted that caddy 100 could be modified to include mounting structures. As stated above, in a preferred embodiment herein, caddy 100 has anti-skid pads 121 (FIGS. 11 and 12) on bottom 120 to further prevent movement during transport.

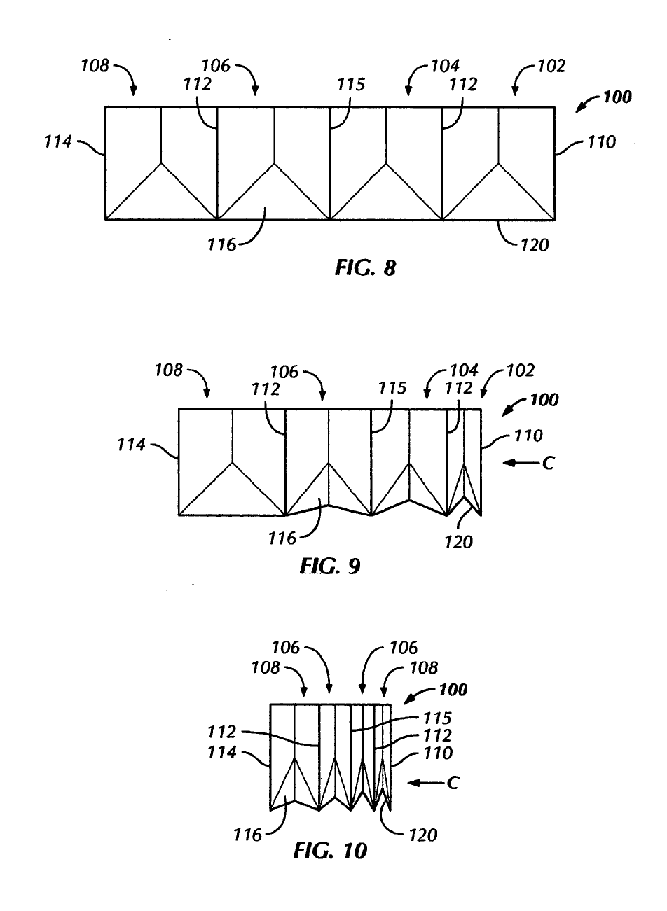

As mentioned above, caddy 100 collapses in the end-to-end direction. This is shown in detail in FIGS. 9, 10, 11, and 12. FIG. 8 shows caddy 100 in a fully open position with panels 110, 112, 114, and 115 being spaced apart to form compartments 102, 104, 106, 108. FIG. 9 shows caddy 100 in a partially closed position with first end panel 110 moved in direction C toward the opposite second end panel 114. Pliable fabric side panels 116, 118 fold inwardly to allow this collapsing motion.

FIG. 10 shows a further partially collapsed position, with first end panel 110 and each of intermediate divider panels 112 and center divider panel 115 moved in direction C toward close proximity with each other and with second end panel 114. FIG. 13 shows the caddy in the collapsed position with panels 110, 112, 114, and 115 being in such close proximity that they actually come into contact with each other to form a very compact stack. Alternatively, the panels may be brought into close proximity without quite touching each other.

This end-to-end collapsing brings out one of the powerful advantages of the present invention, which is the balance between sturdiness, support and collapsibility of caddy 100. More specifically, side panels 116, 118 and bottom panel 120 are large in size. However, these large panels are made of pliable material such as nylon fabric so that they fold up and do not significantly increase the size of the caddy in the collapsed position. Materials other than nylon could be used, as could heavier materials such as canvas. On the other hand, rigid, parallel panels 110, 112, 114, and 115 provide good support for bags and allow the caddy to hold its shape when open and empty. Therefore, the end-to-end collapsing feature of caddy 100 allows several somewhat conflicting design objectives to be simultaneously accommodated.

As shown in FIGS. 3, 4 and 14, another feature of caddy 100 is the folding down action of end panels 110 and 114. First end panel 110 can be rotated in direction R1 down and inward relative to intermediate divider panels 112. As shown in FIGS. 3, 4 and 14, first end panel 110 has been rotated all the way down into a position lying along bottom panel 120, so that first end panel 110 is substantially perpendicular to intermediate divider panels 112. Second end panel 114 can also be rotated in direction R2 down and inward relative to intermediate divider panels 112.

In the preferred caddy 100, the end panels can be rotated because they are sewn to pliable bottom panel 120 along their axis of rotation, and because pliable side panels 116, 118 collapse and fold to allow the rotational motion. It is noted that such rotational motion could be provided for in other ways, such as by a hinge and other hardware, which would allow rotational movement between the end panels and the side and bottom panels of caddy 100.

First end panel can be snugly folded all the way down because height H2 (FIG. 13) of first end panel 110 is approximately equal to width W of compartment 102. By approximately matching these dimensions, first panel 110 can be held in the folded down orientation by holding a portion of the bottom panel in tension between the seam joining intermediate divider panel 112 to bottom panel 120 and the seam joining first end panel 110 to bottom panel 120. This tension detachably engages first end panel 110 in the folded down position so that it does not pop back up, for example, under the influence of small mechanical shocks.

When the first compartment 102 is not holding a bag, first end panel 110 is preferably rotated all the way down to lie flat against bottom panel 120 in order to keep the effective width of the base of the caddy in its longer condition and thereby to help prevent tipping in the counter-R1 direction (see FIG. 14). Similarly, second end panel 114 can be folded down to maintain the effective width of the base longer and thereby prevent tipping in the counter-R2 direction. In this way, tipping can be minimized even when caddy 100 holds only one or two bags.

Although end panels 110, 114 of preferred caddy 100 can be folded to lie down against bottom panel 120, the end panels could be alternatively dimensioned relative to the width of the compartments 102, 108 so that they can be only partially rotated downward before physical interference with divider panels 112 blocks further rotation. In this alternative embodiment, the end panels would act as sort of a flying buttress, both supporting intermediate divider panels in the upright position while also helping to prevent tipping of the entire caddy by increasing the effective length of the base.

FIG. 5 shows an alternate arrangement of the embodiment of the invention shown in FIG. 4. As shown in place in FIG. 4, end panel 114, in conjunction with the portion of bottom panel 120 that it covers, can be folded upward relative to intermediate panel 112. Side panels 116 and 118 are tucked inward during the folding up process so that they are placed neatly between end panel 114 and intermediate panel 112. Then using Velcro strap 107, the end panel is secured in close relation to intermediate panel 112. For the other end, end panel 110 is positioned similarly. This arrangement then produces and open box configuration with a flat bottom portion and double-thickness ends. Handles 101 are used for transporting the open box. The embodiment of FIG. 5 is particularly useful for larger items that would not otherwise fit within one compartment and also which are relatively heavy and require lifting with handles for convenience.

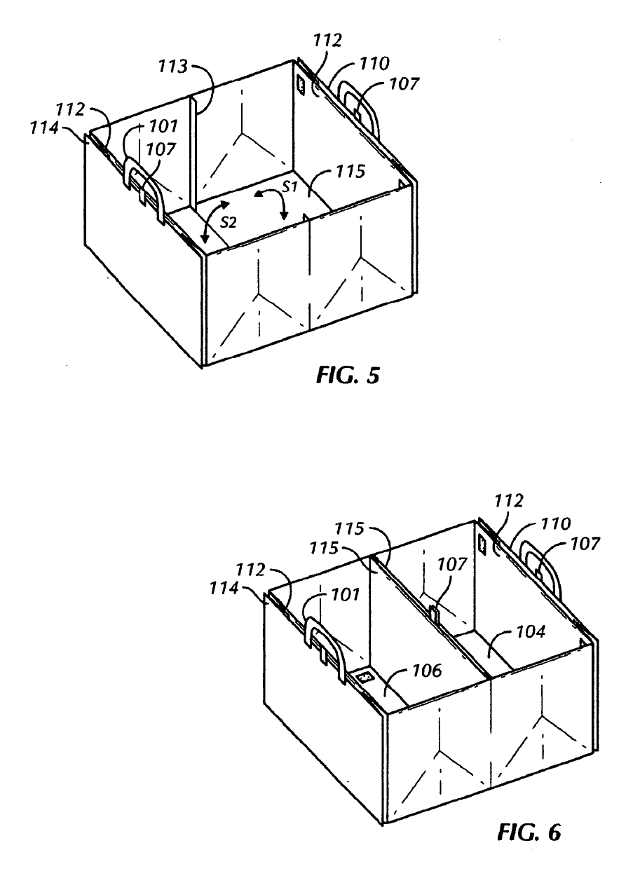

FIG. 6 shows an alternate arrangement of the embodiment of the invention according to FIG. 5. In this arrangement, as compared to the arrangement of FIG. 5, center divider panels 115 have been raised to the upright position, thereby forming two compartments. These dividers can be secured together with straps 107.

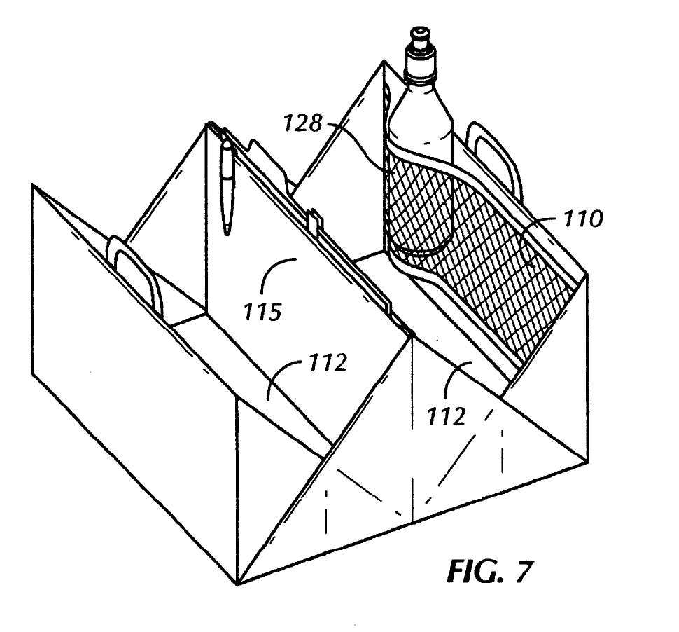

FIG. 7 shows an alternate position of the present invention, suitable for placement on a car seat, or between seats in a van, for example. This configuration is generally referred to herein as the “W” shape, because from the side, it forms the shape of the letter “W.” The W shape is achieved by first folding end panels 110 and 114 inward relative to divider panels 112. As described above, end panels 110 and 114 will be inclined to be substantially perpendicular to divider panels 112. Next, divider panels 112 are also folded down to be inclined substantially perpendicular to center divider panel 115. The first divider panel and second divider panel are movable between a first angular orientation substantially parallel to the center divider panel and a second angular orientation inclined substantially perpendicular to the center divider panel.

Folding down the divider panels causes the end panels to rotate upward, with handle 101 moving to the top of the device. Divider panels 112 are held in the downward position primarily by an interference fit with the side panels and the center divider panel. In addition, hook and loop engagement means 103 and 105 ensure that the divider panels stay in position.

Also as shown in FIG. 7, a water bottle, for example, may be placed in mesh pocket 128, and will be retained within the perimeter of the device. This is particularly advantageous for securing the bottle. In case the bottle becomes unrestrained by the mesh, it will still be held within the confines of the device. In addition, various other personal items, such as a pen or a file folder may be placed between center divider panels 115.

Center divider panel 115 is preferably composed of two substantially rigid panel members, arranged parallel and hinged at the bottom of the device. As shown in FIG. 4, hook and loop fastening means 113 secures the center divider panels in the upright position. However, by disengaging this fastening means, the center divider panels can be rotated downward in the S1 And S2 directions (FIG. 3) to the bottom of the device to be substantially parallel thereto. Tabs 107 located on a top edge of the center divider panels aid in the S1 and S2 rotations. Further hoop and loop fastening means 105 on panel 112 and 103 on bottom panel 120 engage with each other, thereby securing panels 112 to the bottom. This feature is particularly advantageous in holding the W configuration shown in FIG. 7. This thereby forms an enlarged compartment, suitable for larger items, such as container 300 (FIG. 4).

In further embodiments of the invention, another container, such as a cooler bag, may be provided and sized for engagement in the enlarged compartment formed by folding down the center divider panels. Alternatively, other containers having other sizes and shapes may be provided to be retained in any of the compartments of the organizer. As shown in FIG. 4, cooler bag 300 is approximately square in shape and is sized to engage snugly within the enlarged center compartment. Handles 304 allow for convenient placement and removal of the cooler bag from the enlarged compartment. Although not shown in the drawing, it is also contemplated herein that the cooler bag may have a zippered or otherwise closeable cover, may be substantially waterproof and may be constructed of material that reduces the transmission of heat or cold, thereby keeping items therein either cold or hot, depending on the particular application. Cooler bag 300 may also have Velcro patches 302 on one or more exterior surfaces thereof, suitably arranged for engagement with complementary Velcro patches on the divider panels.

In additional embodiments of the invention, the device includes a first end panel having a first side edge, a second side edge and a bottom edge, a second end panel having a first side edge, a second side edge and a bottom edge, a center divider panel having two substantially parallel divider members, each having a first side edge, a second side edge and a bottom edge, and a pliable base. A pliable base is also provided. It will be appreciated that in this embodiment, the first and second divider panels 112 found in previous embodiments, are not present. Also, any type of fasteners, such as clips, clamps, staples, or the like, could be used in place of the hook and loop fasteners shown and described.

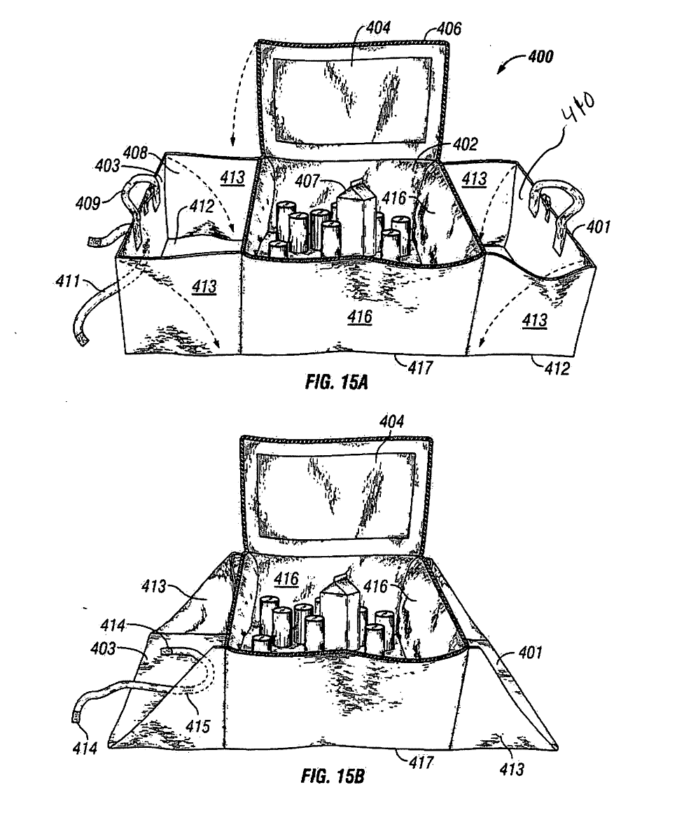

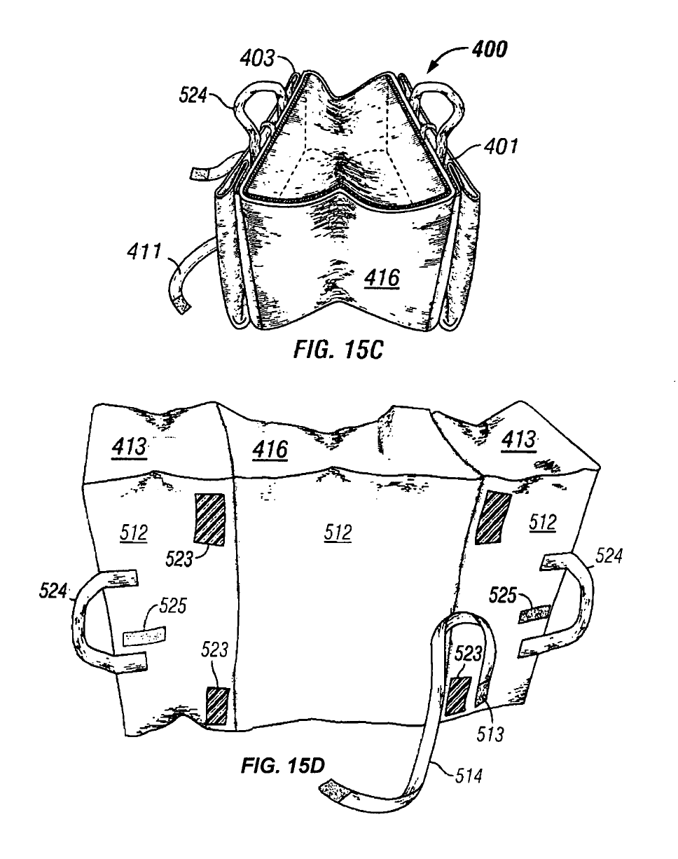

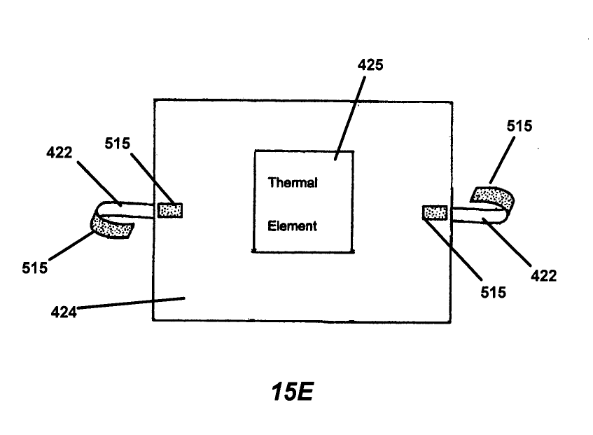

An additional preferred embodiment of the disclosed device herein is depicted in figure FIG. 15A in the form of a cooler caddy 400 having a cooler compartment 402 positioned in between a first end compartment 408 and a second end compartment 410. The end compartments are positioned on opposite ends of the cooler caddy 400. The cooler compartment 402 provides great utility for storing items 407 which are sensitive to temperature and may exhibit symptoms of leaking if overheated, sweating and developing exterior condensation in humid conditions and the like. Further, the cooler compartment 402 provides an excellent means to negate temperature extremes which can develop in car such as a parked car in the summer or winter months. As can be surmised by those skilled in the art, since the cooler compartment 402 is insulated, it may also serve as a compartment to maintain the heat of stored items 407 such as for instance, a pizza. However, when employed to hold items 407 to maintain heat, the lining of the cooler department must be formed of fabric adapted to endure the anticipated temperatures.

The cooler compartment has a lid portion 404 adapted for engagement around portions of its perimeter with the cooler compartment 402 using a means for closing such as a zipper 406 or hook and loop fabric or other closing means suitable to the task. While shown with a fabric hinge along one edge of the lid portion 404 perimeter, which is the preferred mode of this embodiment since it maintains the lid portion 404 in permanent proximity to the cooler compartment 402, a non-hinged version could also be employed. Under the lid portion 404 the cooler compartment 402 is defined by a plurality of cooler sides 416 and the cooler bottom 417. The means for closure, in this case the zipper 406 would be employed to engage the loose perimeter edges of the lid portion 404 to a respective aligned cooler side 416.

The interior lining of the cooler compartment 402 in the preferred mode, employs insulation materials and any suitable moisture barriers that might be desirable to protect the contents 407 stored in the cooler compartment 402. Such linings should also be substantially leak proof to maintain melted ice, water, or condensation, inside the cooler compartment 402 during use. A few materials suitable for the lining include one or a combination of PVC or EVA plastics, and/or closed cell insulation which would have the additional benefit of an insulating factor. The lining may also be of a, or include, a thermal reflective material such as silver heat-sealed vinyl fabric which is adapted for the anticipated temperature of the cooler compartment 402 bet it cool or hot. While reinforced vinyl fabric may serve well as the lining, additional resistance from tearing and abrasion may be desirable in which case canvas, nylon, polyester, or other fabrics which are tear and abrasion resistant may be employed with the lining to increase the cooler compartment resistance to those potential hazards.

As with other embodiments of the device herein, the ability of the cooler caddy 400 to collapse is particularly useful to the user since it allows the device to be expanded for use, or collapsed for storage, or when the entire device is not employed for storage. Further, collapsing the first and second end compartments 408 and 410, aids in insulating the cooler compartment 402 and forms very strong folded support sidewalls with the bottom handles 524 on the upper side of the device for extra support of potentially heavy loads inside the cooler compartment 402. The formed support sidewalls, having the bottom handles 524 attached, are effectively three layers thick with the exterior sides 401 and 403, the interior sides 416, and part of the bottom 416 rotated to a vertical position. They thus insulate better and provide better support to the user of the load when carrying the device.

The collapsible nature of the cooler caddy 400 is depicted in the series of FIGS. 15A-15C. In FIG. 15A the cooler caddy 400 is fully extended or in open configuration. As shown in FIG. 15B a partial collapse is provided by collapsing first and second end compartments 408 and 410. This partial collapse still provides lateral support to the cooler sides 416 during use to keep it from tipping or sliding such as in a moving car, but renders the device smaller. Additional stability would be available by stacking something heavy on top of the flattened end panels 401 and 403. The fully collapsed configuration of the cooler caddy 400 is very similar to that as shown in FIG. 13, and a strap 411 is provided as a means to maintain the cooler caddy in that collapsed position through engagement of the distal ends of the strap 411.

In the fully deployed mode of the cooler caddy 400 shown in FIG. 15A, there is seen a first end compartment 408 and a second end compartment 410 both on opposite sides of the cooler compartment 402 of the cooler caddy 400. Both the first, and second compartments have an area for transport of cargo defined by the depicted plurality of panels. The first compartment 408 is defined by the adjoined surfaces of the first end panel 403, the two side panels 413, the bottom panel 412 and one sidewall defined by a cooler side 416. The second end compartment 410 has a cargo area defined by the second end panel 401, the bottom panel 412, two end panels 413, and the opposite side of the cooler shown as cooler side 418.

In FIG. 15B there is depicted the result of folding the first end 403 and second end 401 downward to a position adjacent to the bottom panels 412 of the respective two compartments. Rotation of the two ends is provided by a fabric hinge formed along their respective engagements to the bottom panel 412 and form a respective axis of rotation of each of the first end 403 and second end 401 toward the bottom panel 412. During this rotation, the pliable side panels 413 will fold and collapse to a position contacting the bottom panel 412 and in frictional engagement with the cooler side 416. During a counter rotation to the vertical position of the end panels, the side panels 413 provide a means to limit the rotation away from the bottom panel 412 and thereby form the two storage compartments. As noted earlier, in the collapsed or folded position of both end compartments, additional support is provided to the cooler compartment 402 when carrying a heavy load therein. The placement of the bottom handles 524, to be deployed above the top surface of the cooler lid 404, gives the user both the increased support, and handles to hold onto when carrying the device.

The end panels 401 and 403 of the cooler caddy 400 are formed to be substantially rigid. This can be accomplished by placing the fabric or material around a rigid interior member during manufacture. The result being that both end panels, when folded to the collapsed position shown in of 15B, provide a rigid strut extending from either cooler side 416. This allows for placing weight on top of the folded end panels 401 and 403 which will maintain the caddy 400 in place better since the projecting portion from the sides is rigid and won't bend or flex as it would with plain fabric.

As shown in FIG. 15C, the rigid end panels 401 and 403 also provide a means for a rigid support to the sides 416 of the cooler compartment 402 and means for a rigid communication between the lower handles 524 and the engagement at the bottom of the cooler sides 416 on both sides of the cooler compartment 402. The resulting rigid sidewalls positioned adjacent to the cooler sides 416 in the collapsed position, will help to maintain the cooler compartment 402 in a fully elevated or enlarged position holding up the lid 404 from two side edges, and, in addition, it will aid by providing a means for protecting the contents of the cooler compartment 402 from side impacts.

As noted earlier, a strap 411 is affixed to the cooler caddy 400 as a means to maintain it in a collapsed position. The strap 411 is affixed to a securing point 415 one outer surface of either the first end panel 403 or the second end panel 401. The strap 411 has a length sufficient to encircle the fully collapsed cooler caddy 400 and secure and maintain that collapsed position. Securement is provided by opposite distal ends of the strap 411 having means for engagement to each other in the form of a fastener. In the current preferred mode, hook and loop fabric works especially well, however any fastener that those skilled in the art would employ, such as snaps, buttons, hooks, eyelets, or buckles, are anticipated.

As shown in 15C, in the semi-collapsed mode of the cooler caddy 400, the panel ends 401 and 403 are substantially vertical and positioned adjacent to opposed cooler sides 416. In this position, the cooler caddy 400 is well supported by the aforementioned rigid nature of the folded panel ends, and easy to carry with the bottom handles 524 having rotated to the top of the device. Total deployment to the collapsed position wherein the strap 411 is employed to maintain the device in a small form for storage or transport, is accomplished by compressing the first end panel 403 toward the second end panel 401 wherein the exterior cooler sides 416 being fabric and supple will tend to bend inward therebetween. Once the first panel end 403 and second panel end 402 are in close proximity with the deformed cooler sides 416 and bottom 512 compressed therebetween, the strap 411 would be cinched around the cooler caddy 400 preferably through the top handles 524 to provide resistance to the strap sliding off.

Finally, an optional component that may be employed for additional utility and is preferred if the cooler caddy 400 is being employed for food transport and delivery such as a restaurant delivery, or transport to the beach for a picnic, there is provided a planar support surface 424 which is adapted for securement to a car seat with one or a plurality of straps 422 having fastening means on the distal ends of the straps engageable to mating fastening means on the support surface 424 A canvas or vinyl material works well for the support surface 424.

The support surface has a top surface which is adapted for removable engagement to the bottom surface 512 of the cooler caddy 400 or the bottom surface of the other embodiments herein. A first fastening means adapted to engage the fasteners 525 on the bottom panel 512 when the cooler caddy 400 is placed thereon, will hold the cooler caddy 400 in position during transport. If hook and loop fabric is employed as the mating fasteners, a simple lifting of the handles 409 or 524 will disengaged the bottom panel 512 from the support surface 420. However during transport, the caddy 400 will remain engaged which is especially important during high speed cornering or fast stops.

Further a thermal element 425 may be provided in a pocket or other means of engagement to the support surface 420 and positioned for a registered engagement underneath the cooler compartment 402 when the cooler caddy 400 is engaged to the top surface 424. Such thermal elements 425 are readily available and plug into the cigarette lighter of conventional vehicles and will radiate heat on one side and cold on the opposite side. Consequently if heat is wanted for communication to the cooler compartment, the thermal element 425 or the entire support surface 424 with a bottom side similar to the top surface 424 can be flipped over to change to heating mode. Alternatively, if the caddy 400 is only hauling heated food or contents, then a resistive thermal element may be employed to impart heat to the caddy 400.

The Multi-Positionable Caddy and Organizer System device, shown in the drawings and described in detail herein, consists of arrangements of elements of particular construction, and configuration for illustrating preferred embodiments of structure and method of operation of the present invention. It is to be understood, however, that elements of different construction and configuration and different steps and process procedures and other arrangements thereof, other than those illustrated and described, may be employed for providing the apparatus herein and still be within the scope of this invention.

As such, while the present invention has been described herein with reference to particular embodiments thereof, a wide latitude of modifications, various changes and substitutions are intended in the foregoing disclosure, and it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. A device for organizing or holding articles in a vehicle, comprising:
a bottom panel;
a first end panel and a second end panel each secured along a first edge, opposite a second edge, to said bottom panel;
said first and second end panels each having a second edge, opposite said first edge;
a cooler compartment having an interior cavity, said interior cavity defined by an area between a top surface opposite said bottom panel, and a sidewall extending in-between said top surface and said bottom panel, said cooler compartment positioned between said first and second end panels; and
said device being collapsible with said cooler compartment in a collapsed position in-between said first end panel and said second end panel.

2. The device of claim 1 further comprising:
a first compartment defined by an area between said cooler compartment and said first end panel; and
a second end compartment defined by an area between said cooler compartment and said second end panel.

3. The device of claim 1 further comprising:
said first and second end panels being substantially rigid; and
said first and second end panels rotatable between a first upright position substantially vertical to said bottom panel, and a second position substantially horizontal and adjacent to said bottom panel.

4. The device of claim 1 additionally comprising:
said cooler compartment having a lid;
said lid selectively positionable from a closed position, to an open position; and
said lid in said open position providing means to access interior cavity.

5. The device of claim 1 further comprising:
a strap secured to said device;
said strap having two ends and having a length sufficient to encircle said device in said collapsed position; and
means to secure said two ends to thereby maintain said device in said collapsed position when encircled by said strap.

6. The device of claim 3 further comprising:
said first and second end panels additionally rotatable from said second position substantially horizontal and adjacent to said bottom panel, to a second upright position adjacent to said sidewall and with said first edge of said first and second end panels positioned adjacent to said top surface of said cooler compartment.

7. The device of claim 6 further comprising:
a first pair of handles each of said first pair of handles engaged to said bottom panel at a position adjacent to said first edge of said first and second end panels; and
each of said first pair of handles projecting positioned adjacent to said top surface of said cooler compartment when said first and second end panels are rotated to said second upright position.

8. The device of claim 1 additionally comprising:
a first pair of handles, one each said first pair of handles secured to one of said first or second end panels at a position adjacent to said second end of said panels.

9. The device of claim 7 additionally comprising:
a second pair of handles one each said pair secured to said pliable base adjacent to one of said first or second end panels.

10. The device of claim 1 additionally comprising:
a support surface engageable to a seat of said vehicle;
said bottom panel having a lower surface on a side opposite said cooler compartment; and
means for removable engagement of said support surface to said lower surface.

11. The device of claim 10 additionally comprising:
said support surface having a thermal element adapted to selectable heat or cool said support surface; and
said thermal element positioned to be located under said cooler compartment when said bottom panel is removably engaged with said support surface.

12. The device of claim 8 additionally comprising:
each of said first pair of handles having an aperture; and
each said aperture providing means to secure a seat belt of said vehicle therethrough thereby providing means to secure said device to a support surface in said vehicle.

13. The device of claim 8 additionally comprising:
said device being collapsible with said cooler compartment in said collapsed position in-between said first end panel and said second end panel by translation of said first end panel toward said second end panel.

14. A device for holding articles in a vehicle, comprising:
a rigid first end panel having a lower edge and opposite distal edge and rigid second end panel having a lower edge and an opposite distal edge, each of said first end panel and second end panel engaged at a respective said lower edge, to one of two opposite ends of a pliable base;
a cooler compartment having an interior cavity, said interior cavity defined by an area between a top surface opposite said bottom panel, and a sidewall extending in-between said top surface and said bottom panel, said cooler compartment positioned between said first and second end panels; and
said device being collapsible with said cooler compartment in a collapsed position in-between said first end panel and said second end panel.

15. The device of claim 14 additionally comprising:
a first pair of handles, one each said first pair of handles secured to one of said first or second end panels at a position adjacent to said distal edge of said panels.

16. The device of claim 15 additionally comprising:
a second pair of handles one each said pair secured to said pliable base adjacent to one of said first or second end panels.
